(19) United States
(12) Patent Application Publication
(10) Pub. No.: US 2026/0276902 A1
(43) Pub. Date: Sep. 17, 2026

(54) OPTICAL FIBER FERRULE TYPE CONNECTORS AND FABRICATION METHOD

(71) Applicant: Samba Photonics Lab Inc., Irvine, CA (US)

(72) Inventors: Xiaolin Tong, Irvine, CA (US); Xiaotian Steve Yao, Las Vegas, NV (US)

(73) Assignee: Samba Photonics Lab Inc., Irvine, CA (US)

(21) Appl. No.: 19/079,355

(22) Filed: Mar. 13, 2025

(51) Int. Cl. G02B 6/38

(52) U.S. Cl. CPC G02B 6/3846; G02B 6/3839

(57) ABSTRACT

An optical fiber connector for an optical fiber cable has a structure that lends itself to modular design and allows for separate production and assembly processes to be carried out at different locations. The connector includes short stub fibers mounted in a ferrule and a V-groove structure to connect the stub fibers with optical fibers of the cable. Also disclosed is a multifiber termination assembly that forms a modular part of the optical fiber connector, allowing the optical fiber connector to be produced and assembled in separate processes at different locations. The multifiber termination assembly includes the short stub fibers and the V-groove structure. Also disclosed is a fabrication method for optical fiber connectors that involve separate production and assembly processes carried out at different locations; the fabrication method is made possible by the modular design of the above optical fiber connector.

### BACKGROUND OF THE INVENTION

This invention relates to a fabrication method for optical fiber ferrule type connectors, in particular, MPO (multi-fiber push-on) connectors, as well as related optical fiber connector structures.

With the wide application of artificial intelligence (AI) technology, the optical fiber connector market is developing rapidly, and the market demand is increasing rapidly, which puts higher requirements on the efficiency of optical fiber connection manufacturing. According to some reports, based on the predicted number of high-speed optical modules and application scenarios of various AI end customers from 2025 to 2029, the demand for nearly 55 million MPO fiber connectors and 136 million LC (Lucent Connector) fiber connectors can be expected. The existing manual assembly process, and the production efficiency of grinding after cable formation, polishing and then testing are difficult to meet the needs of the market.

Of different types of optical fiber connectors, single-channel connectors are mainly used for low density cabling and simple transmission requirements. The market demand for this type of connectors is relatively stable, with suitable applications for general communication and cabling scenarios. Multi-channel connectors are suitable for high-density cabling and complex data transmission needs. The market demand for such connectors is growing rapidly, especially in the field of data center and high-speed communication. Multi-channel connectors can provide higher bandwidth to meet the needs of big data and cloud computing. According to market research data, the global optical fiber connector shows a rapid growth trend. There is a need for development of new optical fiber connectors and new processing technology and assembly process to improve production efficiency.

### SUMMARY OF THE INVENTION

The present invention is directed to a fabrication method for optical fiber ferrule type connectors that substantially obviates one or more of the problems due to limitations and disadvantages of the related art.

An object of the present invention is to provide a manufacturing method for optical fiber ferrule type connectors that improves manufacturing efficiency and reduces manufacturing cost.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve the above objects, the present invention provides an optical fiber connector for an optical fiber cable, the cable including a plurality of optical fibers enclosed in an outer sheath, the optical fiber connector including: a ferrule; a plurality of stub optical fibers mounted in the ferrule, each stub optical fiber having a polished front end exposed at a front end of the ferrule and a back portion extending from a back end of the ferrule; a V-groove structure connected to the ferrule, including a block with a plurality of V-shaped grooves on its surface, wherein the back portion of each stub optical fiber is disposed within one of the plurality of V-shaped grooves; and a cable connection assembly connected to the V-groove structure, having a center through hole through which a portion of the plurality of optical fibers of the cable pass, and a tubular portion bonded to an end of the outer sheath of the cable, wherein an end portion of each optical fiber of the cable is disposed within one of the plurality of V-shaped grooves and in contact with a corresponding end of one of the stub optical fibers, and the optical fibers of the cable are mechanically and optically coupled to the stub optical fibers.

In another aspect, the present invention provides a multifiber termination assembly of an optical fiber connector, which includes: a ferrule; a plurality of stub optical fibers mounted in the ferrule, each stub optical fiber having a polished front end exposed at a front end of the ferrule and a back portion extending from a back end of the ferrule; and a V-groove structure connected to the ferrule, including a block with a plurality of V-shaped grooves on its surface, wherein the back portion of each stub optical fiber is disposed within one of the plurality of V-shaped grooves.

In another aspect, the present invention provides a fabrication method for an optical fiber connector for an optical fiber cable, the cable including a plurality of optical fibers enclosed in an outer sheath, the method comprising: forming a multifiber termination assembly, the multifiber termination assembly including a ferrule, a plurality of stub optical fibers mounted in the ferrule, and a V-groove structure connected to the ferrule, wherein each stub optical fiber has a back portion extending from a back end of the ferrule and disposed within a V-shaped groove of the V-groove structure; assembling a cable connection assembly with the cable, so that a portion of the optical fibers of the cable pass through a center through hole of the cable connection assembly, and a tubular portion of the cable connection assembly is bonded to an end of the outer sheath of the cable; and assembling the multifiber termination assembly with the cable connection assembly, including optically and mechanically coupling the stub optical fibers of the multifiber termination assembly and the optical fibers of the cable, and mechanically connecting the multifiber termination assembly with the cable connection assembly.

It is to be understood that both the foregoing general description and the following detailed description are exemplary and explanatory and are intended to provide further explanation of the invention as claimed.

### BRIEF DESCRIPTION OF DRAWINGS

FIGS. 1A-1C and 2A-2B illustrate a multifiber termination assembly of an optical fiber connector and its components according to an embodiment of the present invention.

FIG. 3 illustrates a cross-sectional view of an optical fiber connector in an assembled state according to an embodiment of the present invention.

FIG. 4 illustrates the optical fiber connector in a partially assembled and the assembled state according to an embodiment of the present invention.

FIGS. 5A-5B illustrate a spring pusher of the optical fiber connector.

FIGS. 6A-6E illustrate a housing of the optical fiber connector.

FIG. 7 illustrates the structure of an optical fiber cable used in embodiments of the present invention.

FIGS. 8-11 illustrate portions of the optical fiber connector in various partially assembled states according to an embodiment of the present invention.

FIG. 12 illustrates two optical fiber connectors according to embodiments of the present invention connected to each other with an adapter.

### DETAILED DESCRIPTION OF THE INVENTION

One aspect of the present invention is to employ multiple separate and independent production and assembly processes for the fabrication of optical fiber connectors. More specifically, separated production processes are employed to fabricate two sub-assemblies, namely, (1) a multifiber termination assembly and (2) pre-cut fiber cables, which may be carried out at different manufacturing facilities at different locations, and the two sub-assemblies (and other required components) are then assembled together to form the finished optical fiber connectors at one of the two different manufacturing facilities (preferably, the one that produces the pre-cut fiber cables) or a third manufacturing facility. To enable the two sub-assemblies to be assembled together, the multifiber termination assembly has a V-groove coupling structure for connecting pairs of optical fibers, as will be described in more detail later.

The multifiber termination assembly has relatively small size and weight, and its production involves relatively complex processes such as gluing the fibers to the ferrule, curing, end cutting, polishing and testing, as will be described in more detail later. The pre-cut fiber cable has relatively large size and weight as it includes the entire length of the optical fiber cable, but its preparation is relatively simple, as will be described in more detail later. After the multifiber termination assemblies are produced at a first factory at a first location, they may be transported, at relatively low transportation cost due to their small sizes and weights, to a second factory where the pre-cut fiber cables are produced, and assembled with the pre-cut fiber cables. The assembly process does not require gluing the fibers to the ferrule, or fiber end grinding and polishing, and can be automated to a large extent. The assembly process may alternatively be carried out at a third factory which is preferably located near the second factory. This overall fabrication process improves production efficiency and shortens delivery time.

As a result, the overall production process is not limited by geographic regions, and the different factories may be arranged in different regions. The multifiber termination assemblies may be prefabricated in advance and then sent to other factories for assembling with the pre-cut fiber cables, which allows for quick response to market demands.

In another aspect, the present invention provides a multifiber termination assembly, which includes short optical fibers with a multi-fiber termination ferrule and a V-groove structure to facilitate connection with the pre-cut fiber cable. The multifiber termination assembly allows the overall structure of the optical fiber connector to be modular. The design of the multifiber termination assembly facilitates automated assembly with the pre-cut fiber cables and provides a kit for automation.

To summarize, embodiments of the present invention employ modular design and independent production and assembly processes for the production of optical fiber ferrule type connectors. An MPO (multi-fiber push-on) connector is used in the descriptions below as an example, but the invention is not limited to MPO connectors and is applicable to other optical fiber ferrule type connectors.

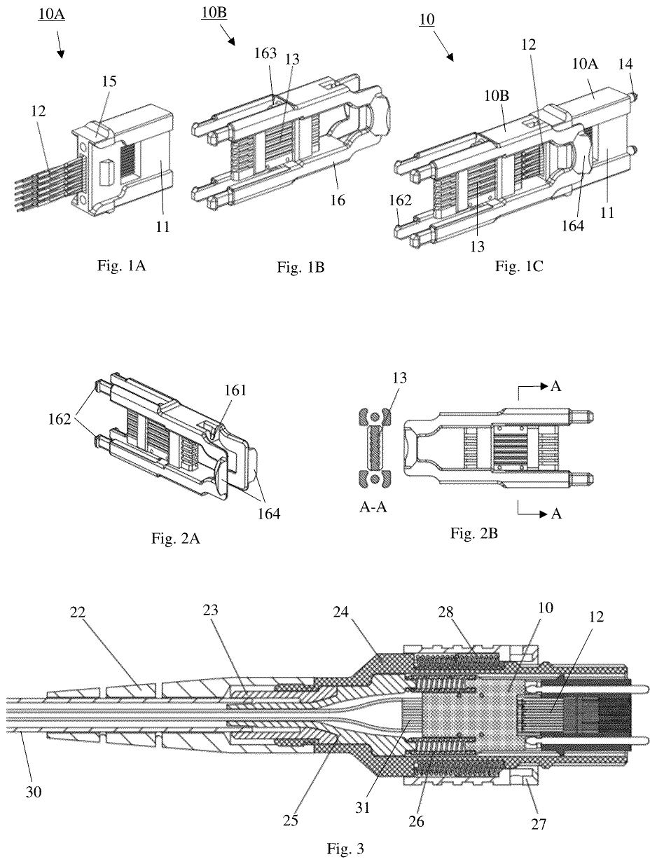

The structure of the multifiber termination assembly is described with reference to FIGS. 1A-1C and 2A-2B. As shown in FIGS. 1A-1C, the multifiber termination assembly 10 includes a ferrule 11, multiple short optical fibers (referred to as stub fibers) 12, a V-groove structure 13, and two alignment pins 14. In the illustrated embodiment, the multifiber termination assembly is formed of two components assembled together. The first component is a ferrule component 10A (FIG. 1A) which includes the ferrule 11 and the multiple stub fibers 12 mounted in the ferrule. The ferrule may be a single-mode or multi-mode ferrule. The front end of the ferrule with polished fiber ends forms the end of the optical fiber connector for optical coupling to another optical fiber connector. A portion of each stub fiber 12 extends outward from the back end of the ferrule. The ferrule is for physical interconnection of optical fibers, to ensure that optical fibers are accurately aligned and securely connected.

The second component is a V-groove component 10B (FIG. 1B) which includes the V-groove structure 13, i.e., multiple V-shaped grooves (V-grooves) linearly arranged in an array. FIGS. 2A-2B show additional views of the V-groove component 10B. In the example shown in FIG. 2B, the V-groove structure is a block with two sets of V-shaped grooves on two opposing surfaces of the block. The ferrule component 10A and the V-groove component 10B are mechanically coupled to each other, such that the exposed portions of the stub fiber 12 are respectively situated in the V-grooves, occupying a portion of the V-grooves (FIG. 1C). The V-grooves enable precise alignment and coupling of the stub fibers 12 with the optical fibers of the cable, as will be described in detail later. The two components 10A and 10B have plastic outer structures 15 and 16 respectively, and the two components may be mechanically affixed together by snap structures (e.g., resilient hooks or tabs and corresponding slots for accommodating the hooks or tabs) formed on their outer structures.

Two pins 14 are provided, which pass through the ferrule component 10A and has one end embedded in a pin inserting slot 161 of the V-groove component 10B. The pins 14 protrude from the front end of the ferrule component, and serve to guide the ferrules of two optical fiber connectors to connect with each other, ensuring the precision of connection between the two ferrules.

The overall structure of the optical fiber connector is described with reference to FIG. 3 (cross sectional view, assembled) and 4 (exterior view, partially assembled and assembled). In addition to the multifiber termination assembly 10, other components of the connector include: an inner support 23, a housing 24, a spring pusher 25, inner springs 26, outer springs 28, and a housing stayer 27. The inner support 23, the spring pusher 25, and the multifiber termination assembly 10 are disposed at least partially inside the housing. A boot 22, which is a cable bending protection structure, surrounds an end portion of the optical fiber cable 30 and a portion of the optical fiber connector.

The inner support 23 is a tubular shaped cable bending protection structure that surrounds an end portion of the optical fiber cable and is located inside the boot. The housing 24 is an enclosure structure with a cavity that securely encases and protects the internal components of the connector, providing structural protection for the internal fiber connection as well as cable boot fixation. The spring pusher 25 connects with the cable 30, and connects with the multifiber termination assembly 10 while supporting the inner springs. The spring pusher 25 also functions to protect against bending of the optical fibers inside the connector when the multifiber termination assembly is squeezed. As shown in FIG. 3, a tubular portion of the spring pusher 25 surrounds the optical fibers, the inner support 23 surrounds the tubular portion of the spring pusher and a portion of the optical fiber cable (the inner support and the tubular portion of the spring pusher are preferably bonded to the outer sheath of the cable), a tubular portion of the housing 24 surrounds a portion of the inner support 23, and the boot 22 surrounds a portion of the housing, a portion of the inner support, and a portion of the optical fiber cable.

Multiple (e.g., two) inner springs 26 are disposed longitudinally inside the housing 24 and compressed between the spring pusher 25 and the multifiber termination assembly 10. They act as pressure springs to push the multifiber termination assembly 10 toward the front end of the connector (i.e. the end that couples with another optical fiber connector), so that the two ferrules of the two connectors are in close contact with each other.

The housing stayer (or grip) 27 is a slidable sleeve disposed outside of the housing 24, and two outer springs 28 are disposed longitudinally outside of the housing and inside of the housing stayer, compressed between a shoulder of the housing and an inner flange of the housing stayer. The two outer springs 28 bias the housing stayer toward the front end of the connector and prevent unlimited sliding of the housing stayer. The housing stayer helps stabilize the connection between the optical fiber connector (e.g. MPO connector) and the adapter (e.g. MPO adapter) that the connector is mechanically connected to. A typical MPO adapter has internal hooks to lock the MPO connector to the adapter, but often the internal hooks do not provide enough locking force to hold the connector. The housing stayer of the connector can prevent the adapter's inner hooks against deformation and keep the MPO connector and MPO adapter securely interlocked with each other.

The structure of the spring pusher 25 is shown in more detail in FIGS. 5A-5B (two perspective views from different angles). The spring pusher has a tubular section 251 with a longitudinal through hole 252 for the optical fibers to pass through. Two arms 253 extend longitudinally from the tube section, with various (e.g., eight) slots 254 formed thereon for connecting with the multifiber termination assembly 10. Two spring guide pins 255 are located at the end of the arms for positioning and retaining one end of the inner springs 26. Multiple (e.g., two) resilient hooks (barbs) 256 also extend from the tubular section 251, which engage with features of the housing 24 to prevent loosening after the spring pusher is inserted into the housing. The spring pusher 25 is preferably a one-piece integrated structure.

Correspondingly, referring to FIGS. 1B, 1C and 2A, the V-groove component 10B of the multifiber termination assembly 10 has multiple (e.g., four) resilient hooks 162 as a part of the outer structure 16, extending longitudinally toward the back. The resilient hooks 162 engage with the slots 254 of the spring pusher 25 to connect the V-groove component and the spring pusher together. The outer structure 16 of the V-groove component 10B also has two spring guide pins 163 for positioning and retaining the other end of the inner springs 26. Thus, the inner springs 26 are disposed between the spring guide pins 255 of the spring pusher 25 and the spring guide pins 163 of the V-groove component 10B, and exert a pressure between the V-groove component and the spring pusher, preventing any loosening. By these structures, the V-groove component 10B (and hence the multifiber termination assembly 10) is securely connected with the spring pusher 25.

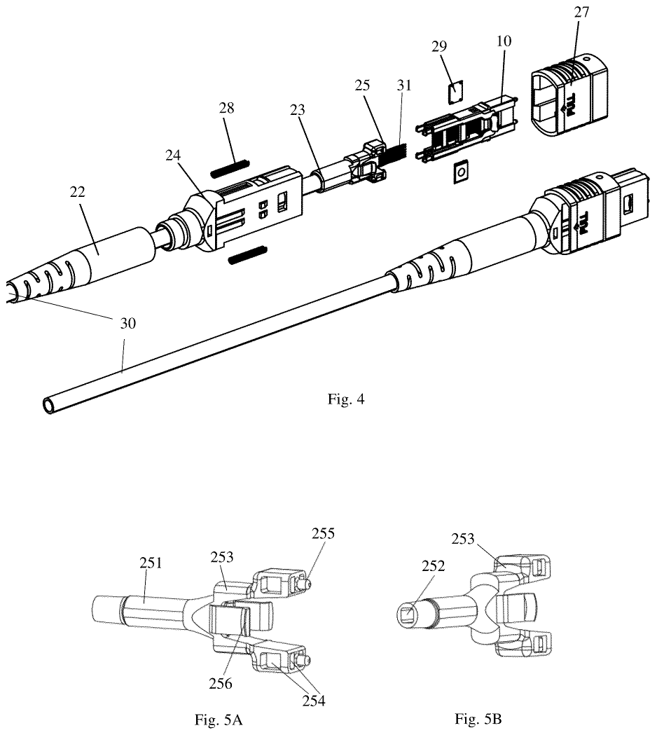

In addition to the mechanical connection of the multifiber termination assembly 10 and the spring pusher 25, the optical fibers 31 of the cable 30 and the stub fibers 12 are optically coupled together via the V-groove structure 13. The ends of the optical fibers 31 and the stub fibers 12 are placed in close contact with each other in the center area of the V-groove structure 13, and permanently connected to each other by an adhesive, such as a UV curable adhesive. The end surfaces of the optical fibers 31 and the stub fibers 12 may be perpendicular to the fibers, or more preferably, form an oblique angle (e.g., about 8 degrees, e.g., 6-10 degrees) relative to the plane perpendicular to the fibers. Two V-groove covers 29 may be placed adjacent to the center area of the V-groove structure to provide physical protection for the cable contact area (see FIG. 4).

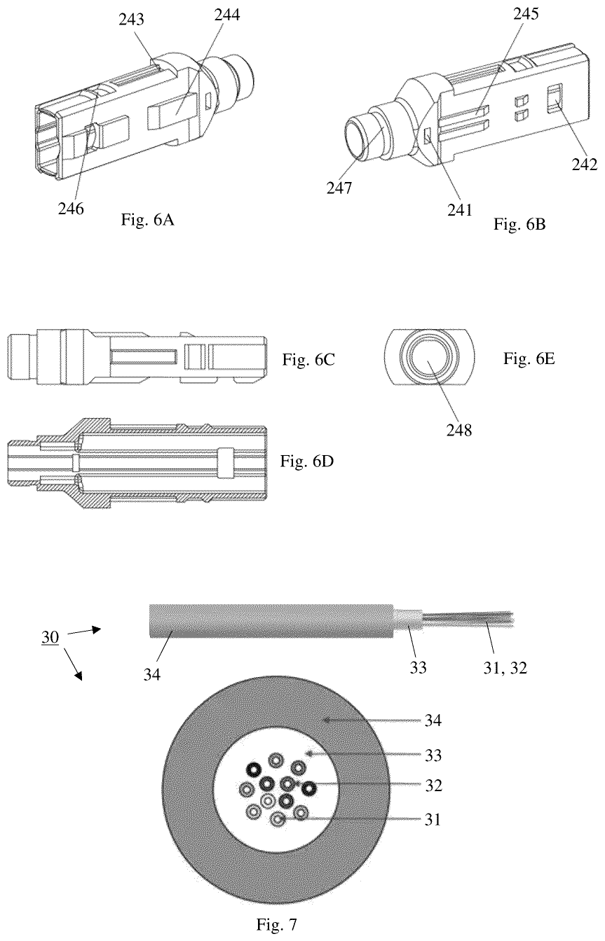

The structure of the housing 24 is shown in more detail in FIGS. 6A-6E. FIGS. 6A and 6B are perspective views from different angles, FIG. 6C is a bottom view, FIG. 6D is a front cross-sectional view, and FIG. 6E is a side view from the side of the cable. The housing 24 is a one-piece integrated structure with high mechanical strength, and provides all outside and inside connecting interfaces for assembling the connector, facilitating easier assembly of the connector.

More specifically, the housing 24 includes multiple (e.g., two) spring pusher hook slots 241 which engage with the resilient hooks 256 of the spring pusher 25 to prevent the spring pusher from sliding out after assembly, and multiple (e.g., two, top and bottom) V-groove hook slots 242 which engage with two corresponding resilient tabs (barbs) 164 formed on the V-groove component 10B (see FIGS. 1C, 2A) to prevent the multifiber termination assembly 10 from sliding out after assembly. Once the optical fibers 31 of the cable 30 and the stub fibers 12 are connected and the multifiber termination assembly 10 and the spring pusher 25 are mechanically connected, the housing 24 can be pushed to the final assembly position, so that the two V-groove barbs 164 are retained inside the V-groove hook slots 242 of the housing by elasticity, and the hooks 256 of the spring pusher 25 are retained inside the spring pusher hook slots 241 of the housing by elasticity. In this state, the center area of the V-groove structure 13 (the internal fiber contact area) is located inside the housing and protected from external contact. This structure also further prevents the multifiber termination assembly 10 from becoming loose.

The housing 24 also includes multiple (e.g., two, top and bottom) spring storage slots 243 for accommodating the outer springs 28; front and rear sliding keys 244 and 245, which are elongated protrusions extending in the longitudinal direction to facilitate easy, quick and precise insertion of the connector into the MPO adapter; and multiple (e.g., two, top and bottom) MPO adapter interlocking slots 246 which engage with hook features of the MPO adapter for connecting the MPO connector to the MPO adapter. The housing 24 also has a boot anti-trip slot 247 around the tubular section. FIG. 6E shows the inner hole 248 of the tubular portion of the housing with an anti-rotation feature for accommodating the inner support 23.

The optical finer connector production and assembly processes are described in more detail below.

The production of the multifiber termination assembly 10 includes gluing the stub fibers 12 to the ferrule 11 (e.g. using epoxy), curing the glue, cutting the fiber ends, polishing the fiber ends, and testing. These steps are generally known in the art of optical fiber connector fabrication, although existing procedures mount optical fibers of the cable, rather than stub fibers, the ferrule. The back end of the stub fibers is cut, preferably at an oblique angle (e.g., about 8 degrees, e.g., 6-10 degrees), and then placed individually inside the V-grooves.

After the multifiber termination assembly 10 has been produced at a first factory, the assembly of the optical fiber connector, preferably carried out at different, second factory, includes the following steps.

Cable cutting: As shown in FIG. 7, the optical fiber cable 30 (which may be either a loose-tube type or a tight-buffered type) includes multiple optical fibers 31 (e.g., 250 μm fibers), each covered by a protective sleeve or a tight buffer coating structure 32, which are then enclosed by an outer sheath 34 along with a strengthening material 33 (such as a polymer yearn or metal wires). In the cable cutting step, parts of the outer sheath and the strengthening material are cut away, such that a length of the fibers is exposed, and a length of the strengthening material is exposed, as shown in FIG. 7.

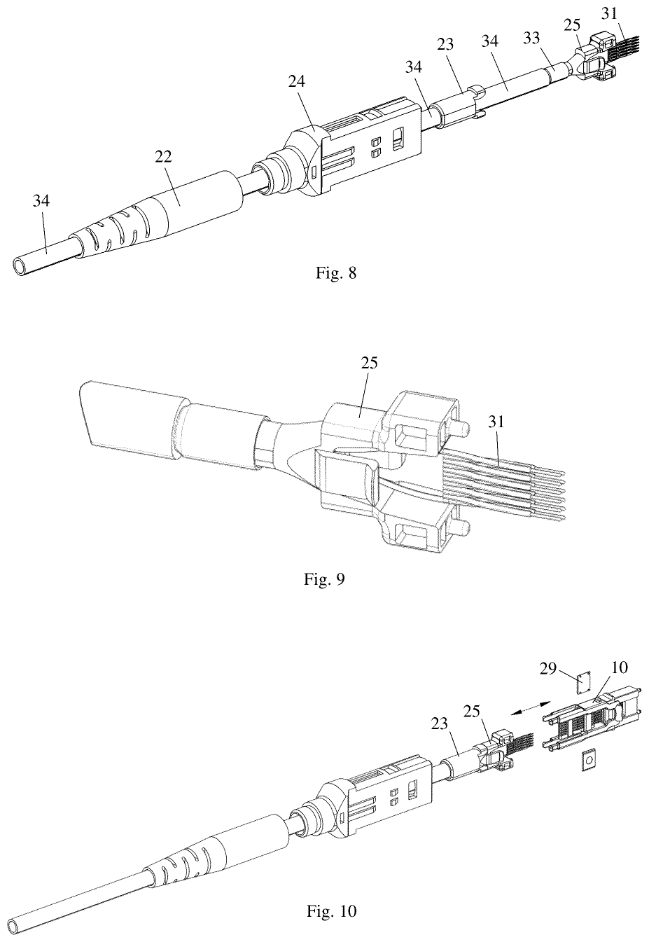

Threading bulk: As shown in FIG. 8, the cable 30 is threaded through the boot 22, the housing 24, and the inner support 23 in that order; the fibers are then threaded through the spring pusher 25, and the tubular section 251 of the spring pusher is inserted inside the outer sheath.

Bonding and curing: The inner support 23 is pushed over the tubular section 251 of the spring pusher 25; then, the inner support 23, the tubular section 251, the outer sheath 34 and the strengthening material 33 are bonded together.

Fiber cutting: The end sections of the fibers 31, after passing through the spring pusher 25, are spread out into an ordered array (e.g., one or two lines), and the fiber ends are cut, preferably at an oblique angle (e.g., about 8 degrees, the same as the angle of the stub fiber), as shown in FIG. 9. A clamp or other suitable tool may be used to hold the fibers while cutting. Laser cutting may be used.

Finally, the multifiber termination assembly 10 is assembled with the pre-cut cable. The optical fibers 31 of the cable are placed the V-grooves of the multifiber termination assembly 10, and the ends of the optical fibers 31 and the stub fibers 12 are pushed together so that the fiber ends tightly contact each other (if the ends are cut at an oblique angle, the optical fibers 31 may rotate as necessary until the two angled surfaces tightly contact each other). An adhesive (e.g., a UV curable adhesive) is injected into the connection area of the V-groove structure and cured to permanently connect the optical fibers 31 and the stub fibers 12 together. The protective V-groove covers 29 may then be installed adjacent to the center area of the V-groove structure. The spring pusher 25 and the multifiber termination assembly 10 are pushed together (with the inner springs 26 in place) and connected with each other, as shown in FIGS. 10 and 11, and held together via the engagement of the resilient hooks 162 of the multifiber termination assembly 10 and the slots 254 of the spring pusher 25.

Then, the housing 24 is pushed to the final assembly position, so that the multifiber termination assembly 10 and the spring pusher 25 are inserted into the housing 24 and connected to the housing via the engagement of the resilient hooks 256 of the spring pusher with the spring pusher hook slots 241 of the housing and the engagement of the resilient tabs 164 of the multifiber termination assembly with the V-groove hook slots 242 of the housing. Finally, the outer springs 28 are installed in the spring storage slots 243 of the housing and the housing stayer 27 is placed over the housing 24.

The final assembly steps, i.e. assembling the multifiber termination assembly 10 with the pre-cut cable, may be carried out at a third factory different from the second factory where the pre-cut cable is prepared.

It should be noted that while the structures of the spring pusher 25 and housing 24 are described in detail, their structures are not limited to those shown and described above; many variations are possible. More generally, the housing 24, inner support 23, spring pusher 25 and the inner springs 26 collectively form a cable connection assembly, which has the following structural features: It has a center through hole through which the cable can pass, allowing the optical fibers of the cable to be connected to the stub fibers of the multifiber termination assembly; it has a tubular portion bonded to an end of the outer sheath and the strengthening material of the cable; and it has mechanical connecting structures that cooperate with corresponding mechanical connecting structures of the multifiber termination assembly to securely connect itself with the multifiber termination assembly. The cooperating mechanical features on the cable connection assembly and the multifiber termination assembly may be resilient hooks or tabs and corresponding slots, other snap type features, or other suitable structures. The cable connection assembly is preferably formed of multiple components assembled together, but it may also be a single-piece integrated structure.

To summarize, one aspect of the invention is an optical fiber connector having a structure that lends itself to modular design and allows for separate production and assembly processes to be carried out at different locations. An important structural feature of the optical fiber connector is the use of short stub fibers mounted in the ferrule, and a V-groove structure to connect the stub fibers with optical fibers of the cable. Another aspect of the invention is a multifiber termination assembly that forms a modular part of an optical fiber connector, allowing the optical fiber connector to be produced and assembled in separate processes at different locations. The multifiber termination assembly includes short stub fibers mounted in a ferrule and a V-groove structure to allow the stub fibers to be connected with optical fibers of the cable. Another aspect of the invention is a fabrication method for optical fiber connectors that involve separate production and assembly processes carried out at different locations; the fabrication method is made possible by the modular design of the optical fiber connector.

Embodiments of the present invention improve production efficiency and lead times. The modular design and independent production and assembly processes mean that production can be performed as regional productions, independent stocks of the multifiber termination assemblies can be maintained, and on-demand configuration of products is possible, with improved production efficiency and delivery time. Embodiments of the present invention also provide kits for automation via modular design. The multifiber termination assemblies, the pre-cut fiber cables, and the final assembly can be made into separated kits and processes which are suitable for automated production.

Embodiments of the present invention can achieve cost competitive design. The separate productions and assembly process of multifiber termination assemblies and pre-cut fiber cables improve the efficiency and increase the turnover of the current production line, improve production efficiency, increase throughput, reduce processing costs, and improve overall production efficiency.

Embodiments of the present invention can achieve high precision alignment. The fibers of the cable and the stub fibers are physically aligned through the V-groove structure and then fixed with UV curable adhesive, which minimizes insertion losses and maximizes optical performance. Embodiments of the present invention can also enhance durability of the connector product. The integrated housing achieves better mechanical strength and product reliability, making the connectors easy to produce and assemble.

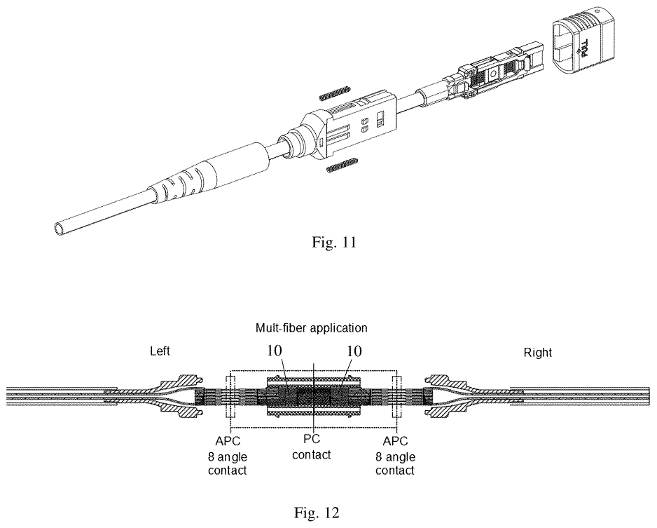

The optical fiber connectors described here are suitable for multi-fiber applications, in which two optical fiber connectors are connected together with an adapter, extending the length of the cables, as shown in FIG. 12. In FIG. 12, “PC” stands for “physical contact” connection and “APC” stands for “angled physical contact” connection between the fibers. The connectors according to embodiments of the present invention can also optimize return loss of the multi-mode fiber application. The intermediate plane contact and the oblique 8-degree angle contact between the stub fibers and the optical fibers of the cable on both sides form an isolation ring which optimizes return loss.

It will be apparent to those skilled in the art that various modification and variations can be made in the optical fiber connector fabrication method and related optical fiber connectors and components of the present invention without departing from the spirit or scope of the invention. Thus, it is intended that the present invention cover modifications and variations that come within the scope of the appended claims and their equivalents.

1. An optical fiber connector for an optical fiber cable, the cable including a plurality of optical fibers enclosed in an outer sheath, the optical fiber connector comprising:
a ferrule;
a plurality of stub optical fibers mounted in the ferrule, each stub optical fiber having a polished front end exposed at a front end of the ferrule and a back portion extending from a back end of the ferrule;
a V-groove structure connected to the ferrule, including a block with a plurality of V-shaped grooves on its surface, wherein the back portion of each stub optical fiber is disposed within one of the plurality of V-shaped grooves; and
a cable connection assembly connected to the V-groove structure, having a center through hole through which a portion of the plurality of optical fibers of the cable pass, and a tubular portion bonded to an end of the outer sheath of the cable,
wherein an end portion of each optical fiber of the cable is disposed within one of the plurality of V-shaped grooves and in contact with a corresponding end of one of the stub optical fibers, and the optical fibers of the cable are mechanically and optically coupled to the stub optical fibers.

2. The optical fiber connector of claim 1, wherein the ferrule, the plurality of stub optical fibers, and the V-groove structure form a multifiber termination assembly.

3. The optical fiber connector of claim 2, wherein the cable connection assembly has one or more first mechanical connecting structures, and the multifiber termination assembly has one or more second mechanical connecting structures, wherein the first mechanical connecting structures and the second mechanical connecting structures cooperate with each other to connect the multifiber termination assembly and the cable connection assembly together.

4. The optical fiber connector of claim 3, wherein the first and second mechanical connecting structures include resilient hooks or tabs and corresponding slots that accommodate the hooks or tabs.

5. The optical fiber connector of claim 3, wherein the cable connection assembly includes:
a housing having a through hole;
a tubular shaped inner support partially disposed inside the housing;
a spring pusher partially disposed inside the inner support and the housing, having a tubular section and a plurality of arms extending from the tubular section, wherein the one or more first mechanical connecting structures are formed on the arms of the spring pusher; and
one or more first springs compressed between the arms of the spring pusher and the multifiber termination assembly,
wherein the optical fibers of the cable pass through the through hole of the housing, the inner support, and the tubular section of the spring pusher, and wherein the inner support and the tubular portion of the spring pusher are bonded to the end of the outer sheath of the cable.

6. The optical fiber connector of claim 5, further comprising a housing stayer disposed outside of the housing, and one or more second springs disposed between the housing and the housing stayer.

7. The optical fiber connector of claim 3, wherein the one or more second mechanical connecting structures are formed on the V-groove structure of the multifiber termination assembly.

8. The optical fiber connector of claim 1, wherein an end surface of the back portion of each stub optical fiber and an end surface of each optical fiber of the cable form an oblique angle of about 8 degrees relative to a plane perpendicular to the respective optical fiber.

9. A multifiber termination assembly of an optical fiber connector, comprising:
a ferrule;
a plurality of stub optical fibers mounted in the ferrule, each stub optical fiber having a polished front end exposed at a front end of the ferrule and a back portion extending from a back end of the ferrule; and
a V-groove structure connected to the ferrule, including a block with a plurality of V-shaped grooves on its surface, wherein the back portion of each stub optical fiber is disposed within one of the plurality of V-shaped grooves.

10. The multifiber termination assembly of claim 9, wherein the ferule and the V-groove structure are individual pieces connected together by snap structures.

11. The multifiber termination assembly of claim 9, wherein an end surface of the back portion of each stub optical fiber is cut at an oblique angle of about 8 degrees relative to a plane perpendicular to the stub optical fiber.

12. A fabrication method for an optical fiber connector for an optical fiber cable, the cable including a plurality of optical fibers enclosed in an outer sheath, the method comprising:
forming a multifiber termination assembly, the multifiber termination assembly including a ferrule, a plurality of stub optical fibers mounted in the ferrule, and a V-groove structure connected to the ferrule, wherein each stub optical fiber has a back portion extending from a back end of the ferrule and disposed within a V-shaped groove of the V-groove structure;
assembling a cable connection assembly with the cable, so that a portion of the optical fibers of the cable pass through a center through hole of the cable connection assembly, and a tubular portion of the cable connection assembly is bonded to an end of the outer sheath of the cable; and
assembling the multifiber termination assembly with the cable connection assembly, including optically and mechanically coupling the stub optical fibers of the multifiber termination assembly and the optical fibers of the cable, and mechanically connecting the multifiber termination assembly with the cable connection assembly.

13. The method of claim 12, wherein the step of forming the multifiber termination assembly is performed in a first factory, the step of assembling the cable connection assembly with the cable is performed in a second factory different from the first factory, and the step of assembling the multifiber termination assembly with the cable connection assembly is performed in the second factory or in a third factory different from the first and second factories.

14. The method of claim 12, wherein the step of forming a multifiber termination assembly includes:
mounting a plurality of stub optical fibers in a ferrule, leaving the back portion of each stub optical fiber extending from the back end of the ferrule;
cutting and polishing a front end of each stub optical fiber exposed at a front end of the ferrule;
cutting a back end of each stub optical fiber which extends from the back end of the ferrule at a predefined angle; and
arranging the back portion of each stub optical fiber in a V-shaped groove of a V-groove structure which is connected to the ferrule.

15. The method of claim 14, wherein the step of assembling the cable connection assembly with the cable includes:
threading the portion of the plurality of optical fibers of the cable through the center through hole of the cable connection assembly;
bonding the tubular portion of the cable connection assembly to the end of the outer sheath of the cable; and
cutting an end of each optical fiber at the predefined angle.

16. The method of claim 15, wherein the step of assembling the multifiber termination assembly with the cable connection assembly includes:
arranging a portion of each optical fiber of the cable in a V-shaped groove of the V-groove structure and in close contact with a corresponding stub optical fiber in the V-shaped groove,
glueing the portions of the optical fibers of the cable and the back portions of the stub optical fibers together; and
mechanically connecting the cable connection assembly and the multifiber termination assembly together using one or more mechanical connecting structures of the cable connection assembly and one or more corresponding mechanical connecting structures of the multifiber termination assembly.

17. The method of claim 16, wherein the predefined angle is an oblique angle of about 8 degrees relative to a plane perpendicular to the respective optical fiber.
